(19) United States
(12) Patent Application Publication
(10) Pub. No.: US 2022/0166219 A1
(43) Pub. Date: May 26, 2022

(54) SYSTEMS AND METHODS FOR MODULAR POWER CONVERSION UNITS IN POWER SUPPLY SYSTEMS

(71) Applicant: General Electric Company, Schenectady, NY (US)

(72) Inventors: Douglas Carl Hofer, Clifton Park, NY (US); Kenneth McClellan Rush, Ballston Spa, NY (US)

(21) Appl. No.: 17/600,373

(22) PCT Filed: Apr. 4, 2019
(86) PCT No.: PCT/US2019/025867

§ 371 Date: Sep. 30, 2021

(51) Int. Cl. H02J 3/32; B60L 53/20; H02J 3/38; H02J 7/00

(52) U.S. Cl. CPC H02J 3/32; B60L 53/20; H02J 3/381; B60L 2210/40; H02J 2300/24; B60L 2210/10; H02J 7/0013

(57) ABSTRACT

A power supply system is provided. A power supply system includes a direct current (DC) bus, a first alternating current (AC) bus, at least one modular power conversion unit, and a battery string. The at least one modular power conversion unit includes a high-frequency direct current to alternating current (DC/AC) transformer electrically coupled between the DC bus and the first AC bus, and a direct current to direct current (DC/DC) converter electrically coupled to the high-frequency DC/AC transformer and the DC bus. The DC/DC converter is electrically coupled between the DC bus and the battery string.

### BACKGROUND

The field of the disclosure relates generally to modular electric power conversion units, and more particularly, to a power supply system that includes at least one modular power conversion unit for flexible configuration of the power supply system.

Electricity generation and consumption should generally be balanced. A load demand, however, continuously and randomly fluctuates. If electricity generation does not respond quickly to such fluctuations, an imbalance between supply and demand can occur, and may be detrimental to network stability and power quality. Further, with the development of renewable energy such as solar power, there is an increasing demand for integrating renewable energy into the power grid.

Conventional direct current to alternating current (DC/AC) converters, however, do not convert direct current at a lower voltage to an alternating current at a higher voltage (i.e., AC voltage is limited to 1/V of the DC voltage, which in practice is about 10% lower to allow for losses and margin). As a result, direct integration of renewable energy to a power grid, which has a higher voltage than the renewable energy generating system, is not readily available.

### BRIEF DESCRIPTION

In one aspect, a power supply system is provided. The power supply system includes a direct current (DC) bus, a first alternating current (AC) bus, at least one modular power conversion unit, and a battery string. The at least one modular power conversion unit includes a high-frequency direct current to alternating current (DC/AC) transformer electrically coupled between the DC bus and the first AC bus, and a direct current to direct current (DC/DC) converter electrically coupled to the high-frequency DC/AC transformer and the DC bus. The DC/DC converter is electrically coupled between the DC bus and the battery string.

In another aspect, a modular power conversion unit is provided. The modular power conversion unit includes a high-frequency DC/AC transformer, and a DC/DC converter. The high-frequency DC/AC transformer includes a DC port configured to be electrically coupled to a DC bus and an AC port configured to be electrically coupled to a first AC bus. The DC/DC converter includes a first converter port and a second converter port. The first converter port is electrically coupled to the DC port of the high-frequency DC/AC transformer. The second converter port is configured to be electrically coupled to a battery string.

In yet another aspect, a method of assembling a power supply system is provided. The method includes forming at least one modular power conversion unit by electrically coupling a high-frequency DC/AC transformer to a DC/DC converter. The method further includes electrically coupling the at least one modular power conversion unit to a DC bus. The method further includes electrically coupling the at least one modular power conversion unit to a first AC bus such that the high-frequency DC/AC transformer is electrically coupled between the DC bus and the first AC bus. The method further includes electrically coupling the at least one modular power conversion unit to a battery string such that the DC/DC converter is electrically coupled between the DC bus and the battery string.

### BRIEF DESCRIPTION OF THE DRAWINGS

FIG. 1 is a schematic diagram of an exemplary power supply system.

FIG. 2 is a schematic diagram of another exemplary power supply system.

FIG. 3 is a flow chart illustrating an exemplary method of assembling a power supply system.

### DETAILED DESCRIPTION

Exemplary embodiments of a power supply system including at least one modular power conversion unit are described herein. The modular power conversion unit includes a high-frequency direct current to alternating current (DC/AC) transformer that can convert direct current (DC) to alternating current (AC) and a direct current to direct current (DC/DC) converter. Further, a battery string can be coupled to the modular power conversion unit, which allows flexible configuration of the power supply system.

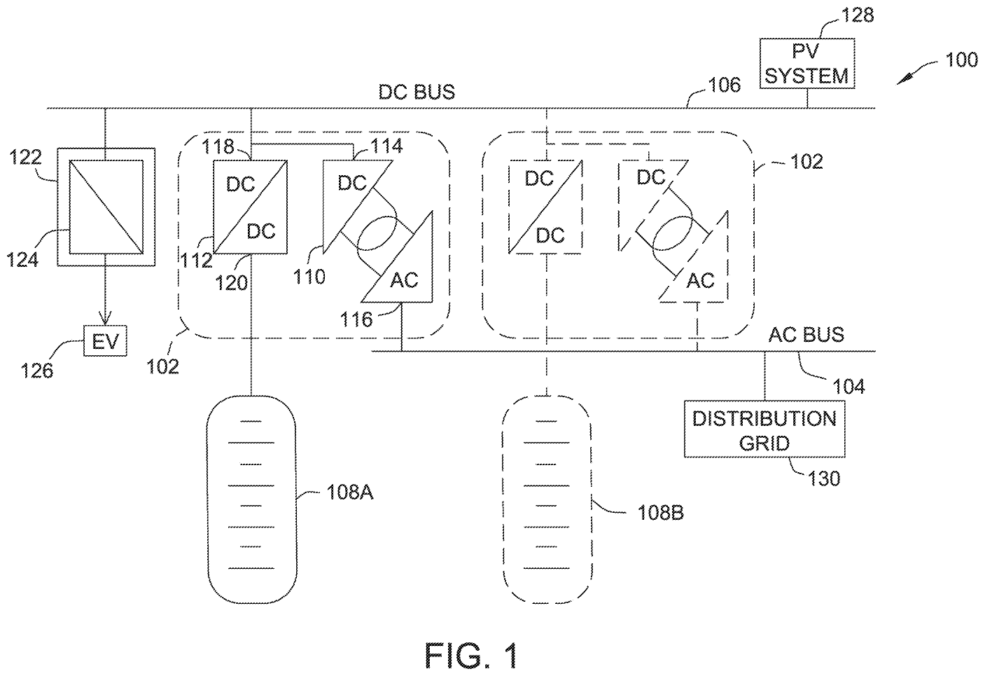

FIG. 1 is a schematic diagram of an exemplary power supply system 100. In the exemplary embodiment, power supply system 100 includes at least one modular power conversion unit 102. Power supply system 100 further includes a first AC bus 104 and a DC bus 106. In addition, power supply system 100 includes a battery string 108. In the exemplary embodiment, modular power conversion unit 102 includes a high-frequency DC/AC transformer 110 and a DC/DC converter 112.

In the exemplary embodiment, high-frequency DC/AC transformer 110 is an integrated converter that works in several stages. The first stage is a DC/AC converter, which converts the DC into a low voltage (lower than the voltage on the DC bus 106) high frequency (e.g., in the magnitude of 10 kHz) AC current. A high-frequency transformer is then used to convert this low voltage, high frequency AC to high voltage, high frequency AC. The high frequency, high voltage AC is then further converted to high voltage low frequency (e.g., 60 Hz or 50 Hz) AC power on the first AC bus 104 for integration to the grid.

Accordingly, high-frequency DC/AC transformer 110 is configured to convert DC electrical power to AC electrical power. High-frequency DC/AC transformer 110 includes a DC port 114 and an AC port 116. The output voltage of a typical DC/AC converter is often less than the input voltage of the DC/AC converter. As such, a DC power line cannot generally be coupled to a distribution bus with a higher voltage than the DC power line using a DC/AC converter. High-frequency DC/AC transformer 110, however, does not have this limitation. Instead, an output voltage of high-frequency DC/AC transformer 110 at AC port 116 may be greater than the input voltage of high-frequency DC/AC transformer at DC port 114. As such, a DC bus can be electrically coupled to an AC bus, e.g., a distribution bus, that has a higher voltage than the DC bus. In some embodiments, high-frequency DC/AC transformer 110 is bidirectional, such that high-frequency DC/AC transformer 110 is capable of converting an AC voltage at AC port 116 to a DC voltage at DC port 114.

In the exemplary embodiment, DC/DC converter 112 includes a first converter port 118 and a second converter port 120. DC/DC converter 112 converts a first DC voltage at first converter port 118 to a second DC voltage at second converter port 120. In some embodiments, DC/DC converter 112 is bidirectional, such that the roles of input and output can be reversed, and second converter port 120 can be used for input and first converter port 118 can be used for output. In the exemplary embodiment, high-frequency DC/AC transformer 110 electrically couples to DC/DC converter 112. In some embodiments, high-frequency DC/AC transformer 110 electrically couples to DC/DC converter 112 by electrically coupling DC port 114 with first converter port 118.

As described above, power supply system 100 includes at least one modular power conversion unit 102. In the exemplary embodiment shown in FIG. 1, power supply system 100 includes two modular power conversion units 102. Alternatively, power supply system 100 may include any number of modular power conversion units 102 that enables power supply system 100 to function as described herein. Modular power conversion units 102 may be electrically coupled to each other in parallel.

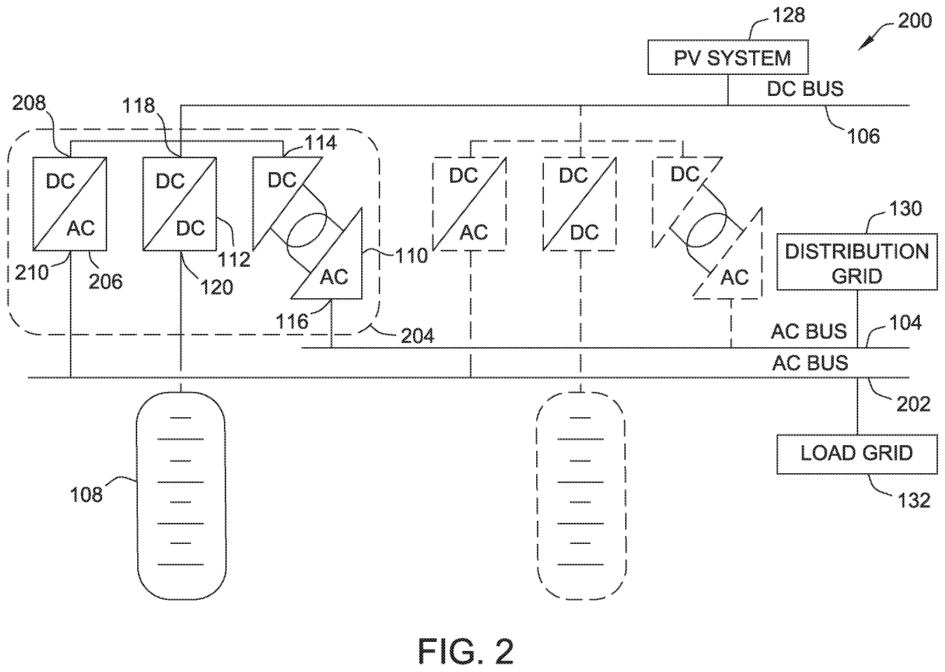

In the exemplary embodiment, first AC bus 104 is configured to be electrically coupled to a power grid. As used herein, a power grid may include wires, substations, transformers, switches, and/or other utility equipment used to transmit electricity from a power source to consumers. A power grid may be, for example, a distribution grid 130 that distributes power to substations at relatively high voltages. Alternatively, a power grid may be a load grid 132 (shown in FIG. 2) that transmits electricity to consumers at voltages much lower than that of distribution grid 130. In some embodiments, first AC bus 104 is a distribution bus. First AC bus 104 may have, for example, a voltage in the range from approximately 4160 Volts (V) to approximately 34.5 kilovolts (kV). In some embodiments, first AC bus 104 is electrically coupled to distribution grid 130. Modular power conversion unit 102 is electrically coupled to first AC bus 104. In the exemplary embodiments, AC port 116 of high-frequency DC/AC transformer 110 is electrically coupled to first AC bus 104.

Battery string 108 includes at least one energy cell, such as a battery, in the exemplary embodiment. Modular power conversion unit 102 is electrically coupled to battery string 108. For example, battery string 108 may be electrically coupled to second converter port 120 of DC/DC converter 112. Battery strings 108 can be selectively added to or removed from the power supply system 100 as needed to achieve desired capacity and production of electric power. Further, battery strings 108 couple to first AC bus 104 through modular power conversion unit 102 (i.e., via DC/DC converter and high-frequency DC/AC transformer) without the need for a distribution transformer, which provides flexibility in configuring power supply system 100. Accordingly, depending on the configuration of the power supply system 100, battery strings 108 can be selectively added and removed by coupling each battery string with a modular conversion unit and adding or removing the modular conversion unit to the power supply system to achieve desired power capacity.

In the exemplary embodiment, the voltage on DC bus 106 is limited to approximately 1500 V or lower consistent with the DC voltage of utility scale PV installations. In some embodiments, DC bus 106 may be idle and not electrically coupled to a DC power source. In other embodiments, DC bus 106 is electrically coupled to at least one DC power source (not shown). An example DC power source is a photovoltaic (PV) power system 128 that converts solar energy to electricity and outputs electricity to DC bus 106. Alternatively, DC bus 106 may be connected to any DC power that enables power supply system 100 to function as described herein. Each modular power conversion unit 102 is configured to be electrically coupled to DC bus 106. In the exemplary embodiment, first converter port 118 and DC port 114 of modular power conversion unit 102 are coupled to DC bus 106.

In some embodiments, DC bus 106 is electrically coupled to an electric vehicle charger 122. Electric vehicle charger 122 may include an electric vehicle (EV) DC/DC converter 124. Electric vehicle charger 122 may be, for example, a charging station. Electric vehicle charger 122 is configured to supply power to an electric vehicle from DC bus 106. In some embodiments, electric vehicle charger 122 is bidirectional, such that electric vehicle charger 122 is configured to discharge power from an electric vehicle 126 into DC bus 106. For example, electric vehicle 126 may be charged during low-demand times and supply electric power to the DC bus 106 during high demand times.

In operation, modular power conversion unit 102 is coupled between DC bus 106 and first AC bus 104. First AC bus 104 is electrically coupled to each modular power conversion unit 102 at AC port 116 of high-frequency DC/AC transformer 110. Further, DC bus 106 is electrically coupled to each modular power conversion unit 102 at both DC port 114 of high-frequency DC/AC transformer 110 and first converter port 118 of DC/DC converter 112.

Further, at least one of the modular power conversion units 102 is electrically coupled between DC bus 106 and a battery string 108. In the exemplary embodiment, battery string 108 is electrically coupled to second converter port 120 of DC/DC converter 112. As such, high-frequency DC/AC transformer 110 of modular power conversion unit 102 converts DC power transmitted through DC bus 106 into AC power at a voltage usable on first AC bus 104. Further, DC power from battery string 108 can be converted to AC power usable on first AC bus 104 using DC/DC converter 112 and high-frequency DC/AC transformer 110. Power from first AC bus 104 can also be converted to DC power and used to charge battery string 108 using high-frequency DC/AC transformer 110 and DC/DC converter 112.

For example, in power supply system 100, first AC bus 104 can charge and discharge battery string 108 as needed. During low-demand times, battery string 108 may be charged by the power supplied from first AC bus 104. In contrast, during high-demand times, battery string 108 may supply electric power to first AC bus 104, e.g., for supplying power into distribution grid 130. In addition, power from PV system 128 transmitted through DC bus 106 may be used to charge battery string 108 such that battery string 108 stores extra power and can be used as a backup power source during high-demand times.

FIG. 2 is a schematic diagram of another exemplary power supply system 200 including a second AC bus 202 electrically coupled to at least one modular power conversion unit 204. Power supply system 200 includes at least some components similar to those in power supply system 100 (shown in FIG. 1), and similar reference numerals are used to designate similar features.

Second AC bus 202 may be, for example, a load bus. Second AC bus 202 may be single-phased, split-phased, or three-phased. A split-phased AC bus may include a three-wire connection with two lines and a neutral for residential customers. Second AC bus 202 is electrically coupled to load grid 132. Voltages on second AC bus 202 may be in a range from approximately 240 V to approximately 1000 V.

In the exemplary embodiment, modular power conversion unit 204 includes high-frequency DC/AC transformer 110, DC/DC converter 112, and a DC/AC converter 206. DC/AC converter 206 includes a DC port 208 and an AC port 210, and is configured to convert DC power to AC power. In some embodiments, DC/AC converter 206 is bidirectional, such that roles of input and output can be reversed and DC/AC converter 206 can be used to convert AC power to DC power. High-frequency DC/AC transformer 110, DC/DC converter, and DC/AC converter 206 are electrically coupled to each other, e.g., at DC port 114, first converter port 118, and DC port 208. In some embodiments, modular power conversion unit 204 is configured to prevent or reduce backfeeding of power from load grid 132 to distribution grid 130 by disabling DC/AC converter 206, disabling the bidirectional capability of DC/AC converter 206, or employing other techniques to prevent electric current from flow from second AC bus 202 to first AC bus 104.

In operation, at least one of modular power conversion units 204 is electrically coupled to battery string 108. In some embodiments, each modular power conversion unit 204 is electrically coupled to battery string 108. In the exemplary embodiment, modular power conversion unit 204 is electrically coupled to battery string 108 at second converter port 120 of DC/DC converter 112. Further, DC bus 106 is electrically coupled to modular power conversion unit 204 at DC port 208 of DC/AC converter 206, first converter port 118 of DC/DC converter 112, and DC port 114 of high-frequency DC/AC transformer 110.

Modular power conversion unit 204 is electrically coupled between DC bus 106 and first AC bus 104, second AC bus 202, and battery string 108. For example, modular power conversion unit 204 is electrically coupled to DC bus 106 at DC port 114 of high-frequency DC/AC transformer 110, first converter port 118 of DC/DC converter 112, and DC port 208 of DC/AC converter 206. Modular power conversion unit 204 is also electrically coupled to first AC bus 104 at AC port 116 of high-frequency DC/AC transformer 110, and is electrically coupled to second AC bus 202, e.g., at AC port 210 of DC/AC converter 206. Further, modular power conversion unit 204 is electrically coupled to battery string 108 at second converter port 120 of DC/DC converter 112. As such, electric power carried through DC bus 106 can be supplied to first AC bus 104, second AC bus 202, and battery string 108. DC power can be further supplied into distribution grid 130 through first AC bus 104 and/or load grid 132 through second AC bus 202. In the exemplary embodiment, power can also flow between battery string 108 and first and second AC buses 104, 202 when DC/AC converter 206, DC/DC converter 112, and high-frequency DC/AC transformer 110 are bidirectional. As such, during high-demand times, battery string 108 can supply power to the power grid through first and second AC buses 104, 202. During low-demand times, battery string 108 can be charged by power from the power grid through first and second AC buses 104, 202.

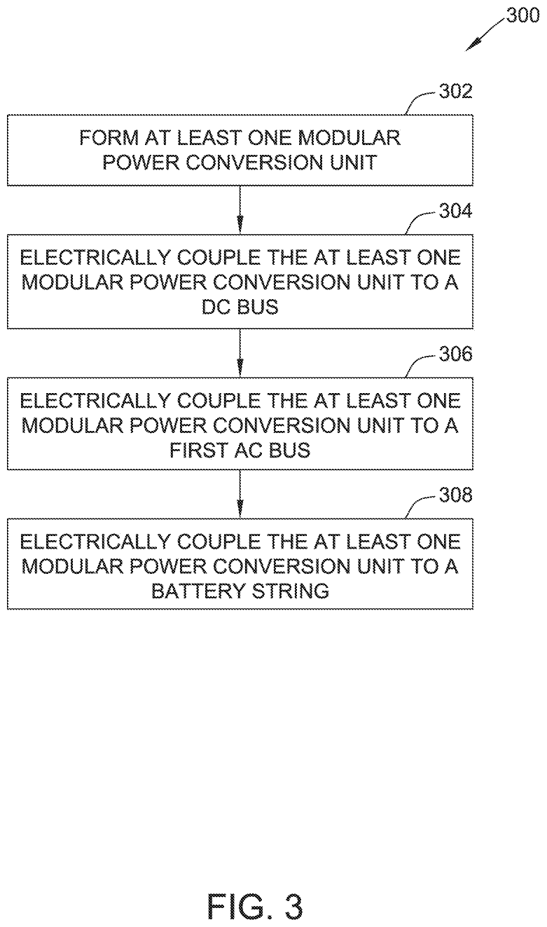

FIG. 3 is a flow diagram of an exemplary method 300 for assembly a power supply system such as power supply systems 100 and 200 (shown in FIGS. 1 and 2). Method 300 includes forming 302 at least one modular power conversion unit by electrically coupling a high-frequency DC/AC transformer to a DC/DC converter. Method 300 further includes electrically coupling 304 the at least one power conversion unit to a DC bus. Further, method 300 includes electrically coupling 306 the at least one modular power conversion unit to a first AC bus such that the high-frequency DC/AC transformer is electrically coupled between the DC bus and the first AC bus. Moreover, method 300 includes electrically coupling 308 the at least one modular power conversion unit to a battery string such that the DC/DC converter is electrically coupled between the DC bus and the battery string.

Exemplary embodiments of systems and methods including modular power conversion units are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

At least one technical effect of the systems and methods described herein includes (a) flexible management of power supply systems; (b) convenient configuration of a power supply system through modular power conversion units; and (c) a power supply system that integrates renewable energy into a smart power grid.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power supply system comprising:
a direct current (DC) bus;
a first alternating current (AC) bus;
at least one modular power conversion unit, said at least one modular power conversion unit comprising:
a high-frequency direct current to alternating current (DC/AC) transformer electrically coupled between said DC bus and said first AC bus; and
a direct current to direct current (DC/DC) converter electrically coupled to said high-frequency DC/AC transformer and said DC bus; and
a battery string, wherein said DC/DC converter is electrically coupled between said DC bus and said battery string.

2. A power supply system in accordance with claim 1, wherein said first AC bus is electrically coupled to a distribution grid.

3. A power supply system in accordance with claim 1, wherein said high-frequency DC/AC transformer is configured to convert a first voltage on said DC bus to a second voltage on said first AC bus, and wherein the first voltage is lower than the second voltage.

4. A power supply system in accordance with claim 1, wherein said at least one modular power conversion unit further comprises a direct current to alternating current (DC/AC) converter electrically coupled to said high-frequency DC/AC transformer, said DC/DC converter, and said DC bus.

5. A power supply system in accordance with claim 4, further comprising a second AC bus, wherein said DC/AC converter is electrically coupled between said DC bus and said second AC bus.

6. A power supply system in accordance with claim 5, wherein said DC bus has a voltage of approximately 1500 Volts (V) or lower, wherein said first AC bus has a voltage in a range from approximately 4160 V to approximately 34.5 kiloVolts (kV), and wherein said second AC bus has a voltage in a range from approximately 240 V to approximately 1000 V.

7. A power supply system in accordance with claim 5, wherein said second AC bus is electrically coupled to a load grid.

8. A power supply system in accordance with claim 1, wherein said at least one modular power conversion unit comprises a plurality of modular power conversion units electrically coupled in parallel with one another.

9. A power supply system in accordance with claim 1, wherein said DC bus is electrically coupled to a photovoltaic system.

10. A power supply system in accordance with claim 1, wherein said DC bus is electrically coupled to an electric vehicle charger.

11. A power supply system in accordance with claim 1, wherein said at least one modular power conversion unit is configured to prevent backfeeding.

12. A modular power conversion unit, comprising:
a high-frequency direct current to alternating current (DC/AC) transformer, wherein said high-frequency DC/AC transformer comprises a direct current (DC) port configured to be electrically coupled to a direct current (DC) bus and an alternating current (AC) port configured to be electrically coupled to a first AC bus; and
a direct current to direct current (DC/DC) converter, wherein said DC/DC converter comprises a first converter port and a second converter port, wherein said first converter port is electrically coupled to said DC port of said high-frequency DC/AC transformer, and wherein said second converter port is configured to be electrically coupled to a battery string.

13. A modular power conversion unit in accordance with claim 12, wherein said high-frequency DC/AC transformer is configured to convert a first voltage on the DC bus to a second voltage on the first AC bus, and wherein the first voltage is lower than the second voltage.

14. A modular power conversion unit in accordance with claim 12, further comprising a direct current to alternating current (DC/AC) converter, wherein said DC/AC converter further comprises a DC port and an AC port, and wherein said DC port of said DC/AC converter is electrically coupled to said first converter port of said DC/DC converter and said DC port of said high-frequency DC/AC transformer.

15. A modular power conversion unit in accordance with claim 14, wherein said DC port of said DC/AC converter is configured to be electrically coupled to the DC bus, and wherein said AC port of said DC/AC converter is configured to be electrically coupled to a second AC bus.

16. A modular power conversion unit in accordance with claim 12, wherein said modular power conversion unit is configured to prevent backfeeding of electrical power.

17. A modular power conversion unit in accordance with claim 12, wherein said second converter port of said DC/DC converter is configured to be electrically coupled to a battery string including at least one energy cell.

18. A method of assembling a power supply system, said method comprising:
forming at least one modular power conversion unit by electrically coupling a high-frequency direct current to alternating current (DC/AC) transformer to a direct current to direct current (DC/DC) converter;
electrically coupling the at least one modular power conversion unit to a direct current (DC) bus;
electrically coupling the at least one modular power conversion unit to a first AC bus such that the high-frequency DC/AC transformer is electrically coupled between the DC bus and the first AC bus; and
electrically coupling the at least one modular power conversion unit to a battery string such that the DC/DC converter is electrically coupled between the DC bus and the battery string.

19. A method in accordance with claim 18, wherein forming at least one modular power conversion unit further comprises electrically coupling a DC/AC converter to the DC/DC converter and the high-frequency DC/AC transformer.

20. A method in accordance with claim 19, said method further comprising electrically coupling the at least one modular power conversion unit to a second AC bus such that the DC/AC converter is electrically coupled between the DC bus and the second AC bus.
